(19) United States
(12) Patent Application Publication
(10) Pub. No.: US 2017/0242573 A1
(43) Pub. Date: Aug. 24, 2017

(54) OPERATING MECHANISM FOR A HOUSEHOLD APPLIANCE HAVING AN OPERATING ELEMENT AND A DISPLAY AREA CONFIGURED IN THE OPERATING ELEMENT

(71) Applicant: BSH Hausgeräte GmbH, Munich (DE)

(72) Inventors: Ulrich Goss, München (DE); Christoph Ortmann, München (DE); Robert Sachon, München (DE)

(21) Appl. No.: 15/503,013

(22) PCT Filed: Aug. 12, 2015
(86) PCT No.: PCT/EP2015/068511

§ 371 Date: Feb. 10, 2017

(30) Foreign Application Priority Data
Aug. 19, 2014 (DE) 10 2014 216 414.1

(51) Int. Cl. G06F 3/0484; G06F 3/0482; G06F 3/0488; F24C 7/08; G06F 3/0362

(52) U.S. Cl. CPC G06F 3/04847; F24C 7/085; F24C 7/086; G06F 3/0362; G06F 3/04886; G06F 3/0482; F25D 2400/361

(57) ABSTRACT

An operating mechanism for a household appliance includes a rotatable operating element having a display area, and a first display panel configured touch-sensitive and having display areas associated with at least two different functions of the household appliance to enable a user to select one of the functions by touching a corresponding one of the display areas of the display panel. The selected function is defined by a parameter. A display in the display area of the operating element is coupled to the selected function displayed in the corresponding one of the display areas of the display panel, so that the operating element, when actuated, is able to change the parameter of the selected function to thereby set a parameter value which is displayed in the display area of the operating element.

The invention relates to an operating mechanism for a household appliance, having a first display panel and a rotatable operating element. The invention additionally relates to a household appliance having such an operating mechanism and a method for operating an operating mechanism for a household appliance.

Operating mechanisms for household appliances are known in a wide variety of embodiments. In this connection pushbuttons, rocker switches or rotatable operating elements are configured as operating elements. Touch-sensitive operating elements can also be present. Display regions of display devices of said operating mechanisms are also known in a wide variety of embodiments. Such electronic displays can display a wide variety of information about the operating states of the household appliance, or else additionally present further information about the household appliance itself or about preparation programs or recipes, if the household appliance is designed to prepare food and is for example an oven or a microwave oven or a steam cooker. The same is however also possible in the case of household appliances for laundry care, for example a washing machine or a tumble dryer, or in the case of household appliances for storing and preserving food, for example a refrigerator or a freezer or a combined refrigerator/freezer. In addition the same can also be provided for in the case of household appliances for cleaning crockery, for example a dishwasher. Extractor hoods can also be correspondingly configured.

In modern devices the volume of information regarding the information to be displayed is very high, and in modern display panels it is also possible to design and offer different menu levels for the presentation of information.

In addition, in the case of more modern devices it is also known, as regards ease of use and in order to ensure clarity, for an operating element and a display area to be arranged immediately adjacent to one another or even merged into one another in terms of the design, the spatial proximity thereby enabling the user to perceive both the operating element and the display area more readily at a single glance.

An embodiment such as this is known for example from WO 2012/080154 A1.

It is the object of the present invention to create an operating mechanism, a household appliance and a method for operating an operating mechanism in which a simple and clear operating concept is enabled using functionally differently configured elements of the operating mechanism.

This object is achieved by an operating mechanism, a household appliance and a method according to the independent claims.

An inventive operating mechanism for a household appliance comprises a first display panel and a rotatable operating element. A significant idea of the invention can be seen in that this first display panel is configured to be touch-sensitive and at least two different functions of the household appliance can be selected by touching the display panel in a display area associated with the respective function. This thus means that the display panel has display regions in which the functions are indicated or obvious, and thus can be selected by touch. Additionally the operating element itself also comprises a display area. The display in this display area of the operating element is coupled to the function selected via the display panel. A parameter of the selected function can be changed by actuating the operating element, and the parameter value set in this way is then displayed in the display area of the operating element. Thanks to this type of embodiment the functional link between the representational elements of the operating mechanism is configured by implementing a simpler and intuitively more understandable operating concept. The information display is additionally coupled and the information that is displayed in the display panel on the one hand and in the display area of the operating element is presented so as to be clearly and logically linked. This makes it significantly easier for a user to obtain an overview even when extensive information is being presented, to recognize the selected function and to be able to assign and understand the information then additionally offered. This is also achieved in particular in that this function information on the one hand and the additional information about the function on the other hand is displayed in separate displays, the display panels.

Preferably it is provided that the operating element has a rotating ring which surrounds, in particular completely circumferentially surrounds, the in particular fixed display area of the operating element. This means that not the entire operating element has to be rotated, but the manual actuation and relative movement is performed only by a subcomponent of the operating element, in order then in particular to also be able to change the parameter value of the displayed parameter. Because the operating element is thus separated into several components and has a movable and a fixed part, it is possible especially in the case of the fixed display area for information to be presented so as to be permanently perceivable, without any rotation then taking place here too and thereby adversely affecting recognition by a user.

Preferably it is provided that a display panel is configured as a column, in which the functions are displayed as column elements. A very clear and easily perceivable arrangement is thereby enabled as regards the large amount of information to be displayed, such that on the one hand the recognition and selection by touch of the specific subarea of the display panel is also facilitated.

Preferably it is provided that a display panel is designed as at least a 2×2 matrix, and the functions are displayed in the matrix fields. This is an alternative or supplementary embodiment to the arrangement in columns.

In a preferred embodiment it is provided that the operating mechanism has at least two separate display panels. This means the separation of the function display can be improved and the clarity increased. In particular it is provided that the display panels and the operating element are positioned in a row and the operating element is arranged between the display panels. The aforementioned advantages are thereby once again supported. The row in which the display panels and the operating element are arranged can be a line or a column. The display panels are in this case positioned in particular in an arrangement directly adjacent to the operating element, such that in this respect too the aforementioned association and link and thus the full perception of information by a user is supported.

Preferably it is provided that a rotational path of the operating element is displayed visually lengthwise, in particular in a display area of the operating element. This is particularly advantageous in that users can thus recognize at any time the extent to which they have already rotated the rotating ring and what operational control setting, in particular what parameter value setting, is connected thereto. In this way it is possible to avoid incorrect operation or any uncertainty on the part of users regarding the rotational movement of the rotating ring in view of the fact that they can only guess how far they have already rotated the rotating ring.

Furthermore the invention also relates to a household appliance having an inventive operating mechanism or an advantageous embodiment thereof.

In an inventive method for operating an operating mechanism for a household appliance at least two different functions of the household appliance are selected by touching a touch-sensitive display panel of the operating mechanism in a display area associated with the respective function. A display in a display area of the operating element is coupled to the function selected via the display panel and a parameter of the selected function is changed by actuating the operating element. The resultant adjusted parameter value is then displayed in the display area of the operating element. The advantages achievable with this method have already been explained in the presentation of the inventive operating mechanism.

Advantageous embodiments of the inventive operating mechanism must be regarded as advantageous embodiments of the inventive method, wherein to this end the representational features of the operating mechanism are configured alone or in interaction for the realization of the method steps and procedures.

Further features of the invention emerge from the claims, the figures and the description of the figures. The features and combinations of features mentioned above in the description, as well as the features shown alone and combinations of features mentioned below in the description of the figures and/or in the figures can be used not only in the respectively specified combination, but also in other combinations or in isolation, without departing from the scope of the invention. Thus embodiments of the invention must also be regarded as included and disclosed which are not explicitly shown and explained in the figures, but which emerge and can be created from the embodiments explained using separate combinations of features.

Exemplary embodiments of the invention are explained below in greater detail using schematic drawings, in which:

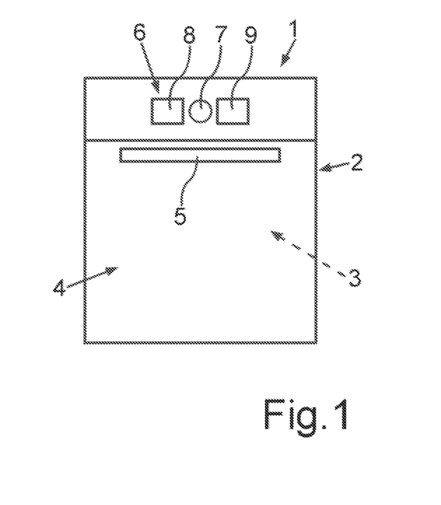

FIG. 1 shows a perspective representation of an exemplary embodiment of an inventive household appliance;

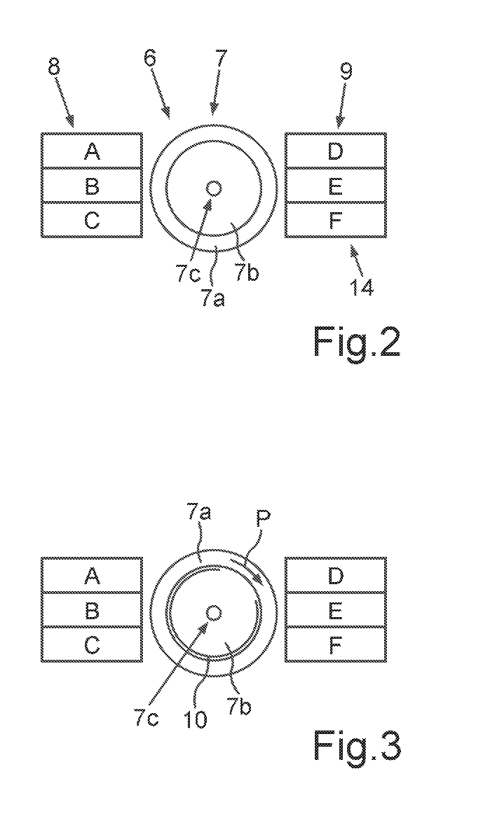

FIG. 2 shows a representation of a first exemplary embodiment of an operating mechanism in a first operating state;

FIG. 3 shows the representation of the operating mechanism according to FIG. 2 in a second operating state;

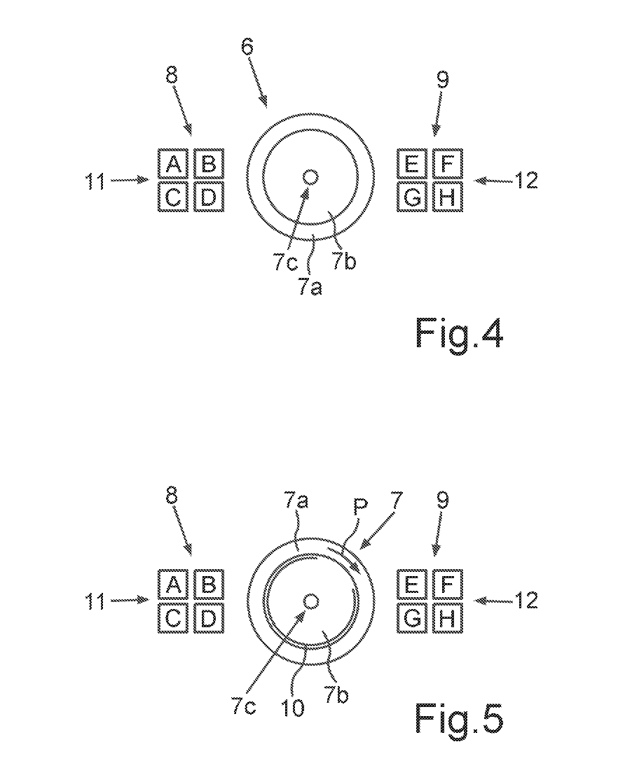

FIG. 4 shows a further exemplary embodiment of an operating mechanism in a first operating state; and

FIG. 5 shows the representation according to FIG. 4 in a second operating state.

In the figures identical or functionally identical elements are provided with the same reference characters.

FIG. 1 shows a household appliance 1 which is designed for the preparation of food and in the exemplary embodiment in particular is an oven. The household appliance 1 for preparing food can however also be a different cooking device. It can also additionally be a household appliance for cleaning crockery or for storing and preserving food or for caring for laundry.

The household appliance 1 comprises a housing 2, in which a cooking compartment 3 is configured, which is delimited by walls of a muffle (not shown). A front loading opening of the cooking compartment 3 and thus also of the muffle can be closed by a door 4. In the exemplary embodiment the door 4 has a door handle 5. Additionally the household appliance 1 has an operating mechanism 6, which has a rotatable operating element 7 and a first display panel 8 as well as a second display panel 9 arranged separate and at a distance therefrom. As can be seen from the representation in FIG. 1, both the electronic display panels 8 and 9 are respectively arranged on opposite sides of the operating element 7, such that the operating element 7 is positioned virtually between the display panels 8 and 9, without further components being arranged between a display panel 8, 9 and the operating element 7. It is provided that the display panels 8 and 9 are arranged immediately adjacent and thus very close to the operating element 7. Additionally the components mentioned are arranged in a horizontal row and thus are positioned virtually in a line. It can however also be provided that the components mentioned, namely the display panels 8 and 9 and the operating element 7, are arranged in a perpendicular row and thus in a column

FIG. 2 shows an exemplary representation of the operating mechanism 6. The operating element 7 can be an individual rotary handle lever. Preferably it is provided that the operating element 7 has a rotating ring 7a which circumferentially fully surrounds a fixed display area 7b of the operating element 7. It can be seen that in the case of the display panel 8, which is configured overall as touch-sensitive, three different functions A, B and C are displayed in a column in respective subregions as an exemplary embodiment. Additionally further functions D, E and F are likewise displayed in a column and in respective subregions in a further display panel 9. The display panel 9 too is configured as a touch-sensitive display panel. In respect of the operating concept it is provided that for example when users wish to select and then perform the function A they press or touch this in the subregion in which this function A is displayed in the display panel 8. It is then selected.

The display of information in the display area 7b of the operating element 7 is coupled to the selection of a function in a display panel 8 or 9. This is implemented such that a parameter of the selected function can be changed by touching the operating element 7, in particular by rotating the rotating ring 7a and a resultant adjusted parameter value 7c is displayed in the display area 7b of the operating element 7. In the present case a display of the parameter in the display area 7b is thus automatically linked to the selection of the function A and by rotating the rotating ring 7a a parameter value is then changed and this is then displayed or the finally adjusted parameter value is then presented. This is also shown in FIG. 3, in which the further operating state is then shown in which after the selection of the function A in FIG. 2 by touching the specific subregion by rotating the rotating ring 7a said parameter value is changed and displayed. The rotation of the rotating ring 7a is also symbolized by the arrow P in FIG. 3. Advantageously the operating element 7 comprises an annularly configured light band, which is arranged adjacent to the rotating ring 7a, and in the exemplary embodiment in particular is arranged on an inside edge facing the display area 7b.

Additionally the light band 10 is formed by light elements which when optically illuminated create a continuous line of light or a line of light segmented in this respect, which then for example is shown as a dashed line. Said light band is preferably likewise fixed in its light sources, such that the rotating ring 7a is moved relative thereto. Said light band indicates to users, and enables them to readily perceive, how far they have already rotated the rotating ring 7a in the direction of movement, and thus also readily enables them to recognize, in respect of maximally adjustable parameter values, how high the adjusted value is already set in comparison to the maximum value and/or the minimum value.

FIG. 4 shows a further exemplary embodiment of the operating mechanism 6. In contrast to the representation according to FIG. 2 and FIG. 3 the functions A to H shown here and in the respective display panels 8 and 9 are not arranged or grouped in columns but are arranged respectively in matrix fields. Thus in FIG. 4 it can be seen that the functions A to D are presented in a 2×2 matrix 11. Accordingly this is implemented in the display panel with the functions E to H, wherein a 2×2 matrix 12 is configured there too.

In the exemplary embodiment shown the display panels 8 and 9 and the operating element 7 are arranged in a horizontal row and thus in a line, and thus are positioned immediately and directly adjacent to one another. In this respect a column can also be configured as a then perpendicular row.

### LIST OF REFERENCE CHARACTERS

1 Household appliance
2 Housing
3 Cooking compartment
4 Door
5 Door handle
6 Operating mechanism
7 Operating element
7a Rotating ring
7b Display area
8 Display panel
9 Display panel
10 Light band

1-9. (canceled)

10. An operating mechanism for a household appliance, comprising:
a rotatable operating element having a display area; and
a first display panel configured touch-sensitive and having display areas associated with at least two different functions of the household appliance to enable a user to select one of the functions by touching a corresponding one of the display areas of the display panel, with the selected function being defined by a parameter,
wherein a display in the display area of the operating element is coupled to the selected function displayed in the corresponding one of the display areas of the display panel, so that the operating element, when actuated, is able to change the parameter of the selected function to thereby set a parameter value which is displayed in the display area of the operating element.

11. The operating mechanism of claim 10, wherein the operating element includes a rotating ring which surrounds the display area of the operating element.

12. The operating mechanism of claim 10, wherein the display panel is designed as a column such that the functions are displayed as column elements in the display areas.

13. The operating mechanism of claim 10, wherein the display panel is designed as an at least 2×2 matrix and the functions are displayed in matrix fields of the matrix.

14. The operating mechanism of claim 10, further comprising a second display panel arranged separately of the first display panel.

15. The operating mechanism of claim 14, wherein the first and second display panels and the operating element are positioned in a row, said operating element being arranged between the display panels.

16. The operating mechanism of claim 10, wherein the operating element is configured to move about a rotational path which is displayed visually lengthwise by a light band.

17. A household appliance, comprising an operating mechanism including a rotatable operating element having a display area, and a first display panel configured touch-sensitive and having display areas associated with at least two different functions of the household appliance to enable a user to select one of the functions by touching a corresponding one of the display areas of the display panel, with the selected function being defined by a parameter, wherein a display in the display area of the operating element is coupled to the selected function displayed in the corresponding one of the display areas of the display panel, so that the operating element, when actuated, is able to change the parameter of the selected function to thereby set a parameter value which is displayed in the display area of the operating element.

18. The household appliance of claim 17, wherein the operating element includes a rotating ring which surrounds the display area of the operating element.

19. The household appliance of claim 17, wherein the display panel is designed as a column such that the functions are displayed as column elements in the display areas.

20. The household appliance of claim 17, wherein the display panel is designed as an at least 2×2 matrix and the functions are displayed in matrix fields of the matrix.

21. The household appliance of claim 17, wherein the operating mechanism includes a second display panel arranged separately of the first display panel.

22. The household appliance of claim 21, wherein the first and second display panels and the operating element are positioned in a row, said operating element being arranged between the display panels.

23. The household appliance of claim 17, wherein the operating element is configured to move about a rotational path which is displayed visually lengthwise by a light band.

24. A method for operating an operating mechanism for a household appliance, comprising:
coupling a display area of an operating element of the household appliance to a touch-sensitive display panel which has display areas associated with at least two different functions of the household appliance;
defining each of the functions by a parameter;
allowing a user to select at least one of the functions by touching a corresponding one of the display areas of the display panel;
adjusting the parameter of the selected respective function by actuating the rotatable operating element to set a parameter value; and
displaying the parameter value in the display area of the operating element.
